(19) United States
(12) Patent Application Publication
(10) Pub. No.: US 2003/0161351 A1
(43) Pub. Date: Aug. 28, 2003

(54) Synchronizing and converting the size of data frames

(76) Inventors: Harlan T. Beverly, McDade, TX (US); Percy W. Wong, Austin, TX (US)

Correspondence Address: Timothy N. Trop, TROP, PRUNER & HU, P.C., STE 100, 8554 KATY FWY, HOUSTON, TX, 77024-1841, US

(21) Appl. No.: 10/081,748

(22) Filed: Feb. 22, 2002

(51) Int. Cl. H04J 3/04; H04J 3/24

(52) U.S. Cl. 370/535; 370/474

(57) ABSTRACT

A data frame of a first size may be converted to a data frame of a second size in a relatively seamless fashion in a gear box. The data may be demultiplexed into blocks of the first size and stored in a register. The data may be read out of the register at a second data size and multiplexed to form an output data frame of the second size. By controlling the reading and writing at different frequencies, the blocks of the first size may be converted to blocks of the second size which correspond to the output data frame size. After the frame size has been converted, the converted data may be aligned in a frame synchronizer by locating synchronization headers within the data. This may be done by moving a window along the data to determine whether or not valid synchronization headers are located in expected positions in a series of successive data frames. In one embodiment, a receiver for a fiber optic network may include a physical layer device that receives serial or parallel data from a fiber optic link and provides it to a physical coding sublayer receive that includes the gear box and the frame synchronizer. The physical coding sublayer receive may be coupled through a parallel interface to a receive media access control.

### BACKGROUND

This invention relates generally to streaming data transfers in networks and computer systems generally.

In handling streaming data frames in association with networks that transfer data at relatively high rates, a data frame of a given size may need to be converted into a data frame of a different size. This is the case, for example, in connection with fiber optic networks such as the ten gigabit base-R Ethernet standards set forth by the Institute of Electrical and Electronic Engineers, Standard 802.3ae (2001) titled “Physical Coding Sublayer (PCS).”

In particular, an available 16-bit data frame must be converted to a 66-bit data frame, pursuant to the standard. Given the high speed of the data that may be involved in ten gigabit Ethernet networks, the conversion process may be complicated by the timing requirements of any components used to do the conversion. In addition, the possibility of clock skews during the conversion may add complications to the system.

Thus, there is a need for a better way to convert data frame sizes at relatively high speeds.

In connection with ten-gigabit base-R Ethernet networks, a physical layer device may receive data from a serial or parallel link such as a fiber optic link. The received data may be in a 16-bit data frame and may be converted to a 64-bit data frame. The 64-bit data frame may then be converted to a 66-bit data frame as described above. The 66-bit data frame, according to the IEEE 802.3ae standard, may include synchronization bits that may be utilized to align the 64-bit data frames and to encode whether or not the data frames constitute data or control information. After the conversion from 64 to 66-bits as one example, it is desirable then to determine where the synchronization bits exist relative to the data frames to align the data frames before they are passed to a receive media access control via a parallel independent interface.

Thus, there is a need for better ways to identify synchronization bits within serial or parallel data.

### BRIEF DESCRIPTION OF THE DRAWINGS

FIG. 1 is an architectural depiction of one embodiment of the present invention;

FIG. 2 is a schematic depiction of one embodiment of the present invention;

FIG. 3 is a depiction of the data in accordance with one embodiment of the present invention;

FIG. 4 is a schematic depiction of a system in accordance with another embodiment of the present invention;

FIG. 5 is a schematic depiction of a system in accordance with another embodiment of the present invention;

FIGS. 6A through 6F are timing diagrams in accordance with one embodiment of the present invention where a valid data frame with synchronization bits is identified; and

FIGS. 7A through 7F are timing diagrams where valid synchronization bits are not identified and a shift is ordered in accordance with one embodiment of the present invention.

### DETAILED DESCRIPTION

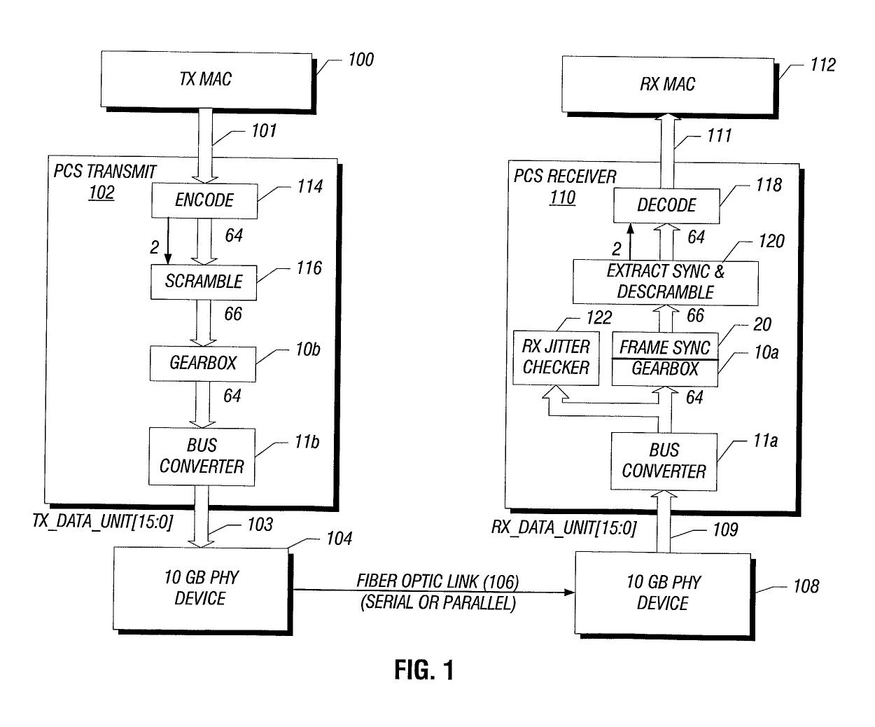

Referring to FIG. 1, in one embodiment of the present invention, a ten-gigabit fiber optic network includes a transmit media access control (MAC) 100 coupled by a parallel ten-gigabit media independent interface (XGMII) 101 to a physical coding sublayer (PCS) transmit 102. While one embodiment of the present invention is illustrated in connection with an optical ten-gigabit transmit-receive system, the present invention is not limited to any particular size, data capacity, or type of communication technology.

The PCS transmit 102 receives a data stream from the transmit MAC 100 and encodes it in an encode 114. The data is then scrambled at 116, taking two bits from the encode 114 and passing those two bits, that are synchronization headers, and 64-bits, that are scrambled, to a gear box lob. The gear box lob converts the 66-bit data frames from the scramble 116 into 64-bit data frames that are passed to a bus converter 11b. The bus converter 11b outputs the data as a 16-bit transmit data unit to a ten-gigabit physical layer (PHY) device 104. An interface 103 between the PCS transmit 102 and the device 104 is a ten-gigabit serial bus interface (XSBI) in accordance with one embodiment of the present invention.

The device 104 transmits the data in a serial or parallel fashion over a fiber optic link 106, in one embodiment, to a receiving ten-gigabit physical layer (PHY) device 108. The device 108 then transmits the data across an XSBI interface 109 to a PCS receive 110.

The PSC receive 110 includes a bus converter 11a that converts the 16-bit data frames to 64-bit data frames and passes those data frames onto a gear box 10a and a receive jitter checker 122. The gear box 10a converts the 64-bit data frames to 66-bit data frames and passes them on to a frame synchronizer 20 that synchronizes and aligns the data frames using the two-bit synchronization headers mentioned earlier.

The synchronized data frames are then passed to a descramble 120 that extracts the synchronization headers and descrambles the remaining data. The 64-bits of descrambled data are then passed to a decode 118 together with two-bits of synchronization header data. In the decode 118, the two-bits of synchronization header encode whether the sixty-four bits is data or control information. The decoded information is then passed across an XGMII interface 111 to the receive media access control (MAC) 112.

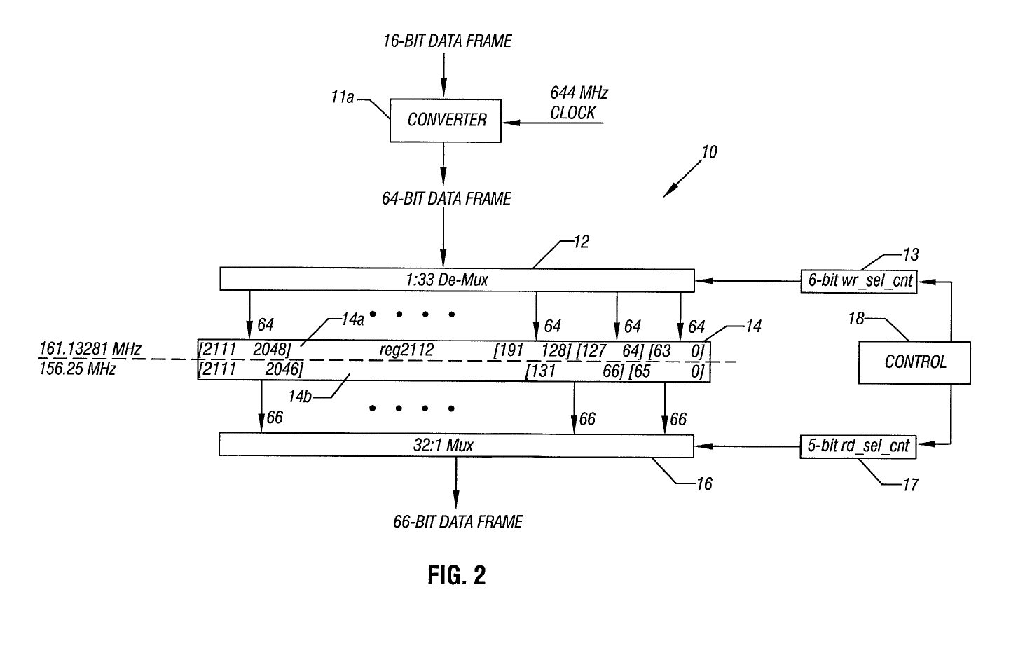

Referring to FIG. 2, in connection with a wide variety of data transfer processes, a given data frame may need to be converted to a differently sized data frame. There are a large number of reasons for doing so. One potential reason is that one system or component may work with one data frame size and another system or component may work with a different data frame size. Thus, it may be necessary to convert data frames of one size to data frames of another size.

For example, the 16-bit data frames received from the PHY device 108 need to be converted to 66-bit data frames. Thus, as shown in FIG. 2, a 16-bit data frame may be converted into a 66-bit data frame using the gear box 10a in one embodiment of the present invention. Similarly, on the transmit side a corresponding gear box 10b converts 66-bit data frames into 64-bit data frames.

Initially, the 16-bit data frame from the PHY device 108 may be converted by the converter 11 to a 64-bit data frame. This may be done by reading and writing from a register clocked at 644 MegaHertz, as one example.

Once the 64-bit data frame has been obtained, it may be applied to a one to thirty-three demultiplexer 12. The demultiplexer 12 converts the 64-bit data into a plurality of 64-bit blocks. In the specific implementation illustrated in FIG. 2, thirty-three 64-bit data blocks amount to 2,112 bits of data. Thus, the demultiplexed 64-bit data frame is applied to a register 14, that in one embodiment may have a capacity of 2,112 bits, accepting thirty-three blocks of 64-bit data.

The clocking of the data from the demultiplexer 12 to the register 14 may be under control of a write select counter 13 that uses a six-bit signal to control the write pointer in the register 12 in one embodiment. The counter 13 may be controlled by a control 18. The control 18 may be a software, firmware or a hardware device.

The register 14 may have a top lane 14a that receives data from the demultiplexer 12 and a bottom lane 14b that allows data to be read by a thirty-two to one multiplexer 16. Thus, the top lane 14a includes thirty-three blocks of data, 64-bits each (such as the bits 63; 0 through 2,111; 2,048).

The counter 13 causes a pointer to be applied to the demultiplexer 12 at a rate of 161.13281 MegaHertz. In other words, the 64-bit writes from the demultiplexer 12 to the register 14 occur at a clock frequency of 161.13281 MegaHertz. This creates the thirty-three blocks of data in the register 14, each of 64-bits. Thus, a write pointer clocked at 161.13281 MegaHertz controls where, within the register 14, the next 64-bit block is written.

Similarly, a read pointer clocked at 156.25 MegaHertz controls where the next 66-bit read is to occur. In other words, the thirty-three blocks of 64-bits each are read out in blocks of 66 bits under control of the read pointer. The read pointer may use a 5-bit signal from a read select counter 17 in one embodiment. Thus, the read output to the multiplexer 16 is thirty-two blocks of 66-bits each. The calculated data width and frequency allows relatively seamless conversion of the 64-bit data frame to a 66-bit data frame.

In the illustrated embodiment, the register 14 is 2,112 bits wide because this allows for an exact multiple of both 64 and 66 or thirty-three 64-bit locations with thirty-two 66-bit locations on opposed lanes 14. This allows for the lanes 14a and 14b to directly map to 64 bits on the write side and 66 bits on the read side.

In accordance with some embodiments of the present invention, a 64-bit data frame may be easily and reliably converted into a 66-bit data frame. In some embodiments, a large register, multiplexers and two counters are all that are needed to implement the conversion. Since there is a register 14 between the multiplexers 12 and 16, in some embodiments, the timing requirements of each multiplexer 12 or 16 may be relaxed by having a pair of opposed multiplexers. In addition, in some embodiments, by keeping the read and write pointers separated and thus creating a buffer, minor clock skews that may occur in the system are accommodated.

Once the sixty-six bit data frames have been formed, it may be desirable to reliably detect and maintain the synchronization header of the sixty-six bit data frame in the frame synchronizer 20. A valid synchronization header may be the first two bits of the sixty-six bit data frame that may have the values of binary 01 or 10 in one embodiment.

In order to achieve synchronization in each sixty-six bit frame, it is desirable to locate the synchronization header. Thus, in every chunk of sixty-six bits of data among the serial stream of a data, each bit may be successively checked to determine whether or not a proper synchronization header has been located. If an invalid synchronization header is detected, a slip signal is generated indicating that the next sixty-six bit data frame candidate should be presented. Each candidate is a sixty-six bit block of contiguous data that starts at a time “N” and continues to time “N plus sixty-five”, repeating thereafter with the next sixty-six bit block.

If the synchronization header is not found, the next candidate starts at a time “N plus one” and ends at a time “N plus sixty-six”. After some amount of time, the synchronization header will be detected with sufficient reliability.

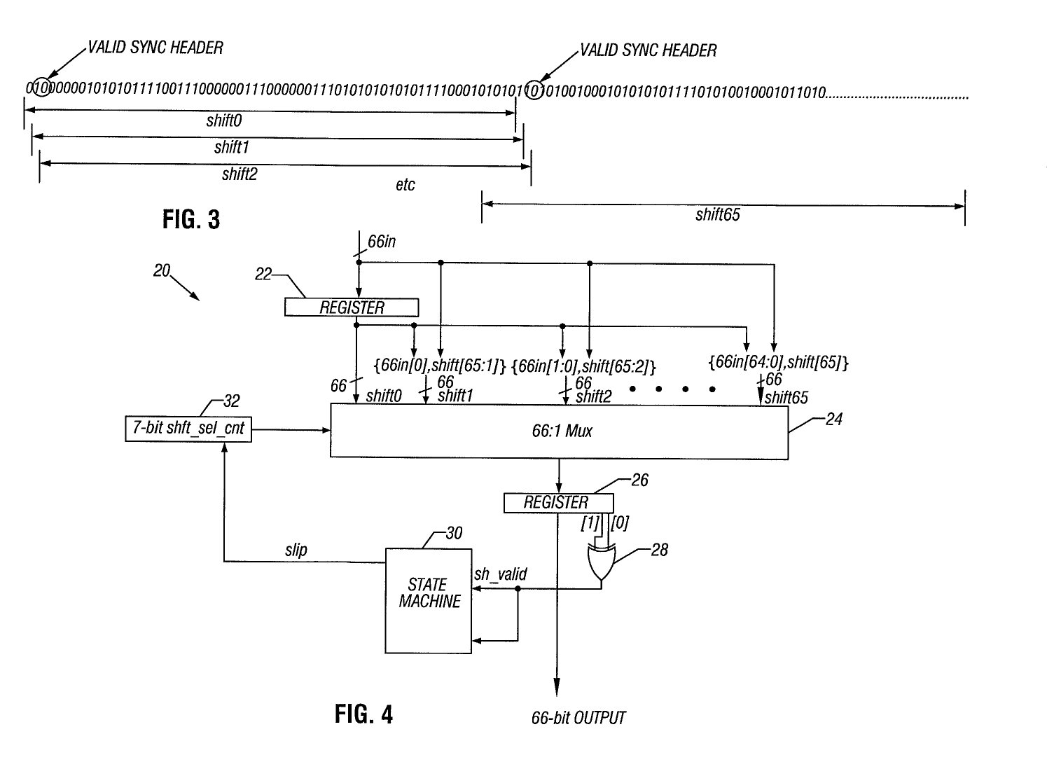

Referring to FIG. 3, a data stream which has a plurality of sixty-six bit blocks is shown in accordance with one embodiment of the present invention. The problem is to find the valid synchronization headers in the streaming data. At shift zero, the first attempt to locate the header, the synchronization header is not found in this example. At shift one, a shift of one cycle to the right, the header (1,0) is found. The synchronization headers of successive sixty-six bit blocks are checked and if a sufficient number of blocks are found to have synchronization headers at the same locations, the synchronization headers are located and it is not necessary to check the next shift. In shift two, if the synchronization headers were not found, shifting one more cycle to the right, another check may be made and so on shifting successively along the data stream until the headers are located.

The sixty-six bit data frame is defined as a data frame formed over sixty-six cycles. After sixty-six cycles, the next cycle overwrites the bit pattern written during cycle one. Thus, the aim in one embodiment is to find, in the serial stream of bits, the true start of the sixty-six bit data frame. Of course other data frame sizes and shift directions may also be used.

Referring to FIG. 4, a state machine 30 counts the number of valid synchronization headers detected for a particular sixty-six bit candidate and determines whether a valid sixty-six bit data frame has been found in one embodiment. If a valid synchronization header is not found, then the next candidate of the sixty-six candidates is presented. Each candidate is presented by shifting a sixty-six bit window, over time, by one bit, starting from the first sample bit. Thus, shift zero is the case where there has been no shift. In one embodiment, shift one is a one-bit shift to the right and shift two is the ensuing two-bit shift to the right and so on.

One issue that arises, when the data in the window is shifted to examine data along the data stream, is that the data to be placed in the open position after the shift is indeterminate. In other words, there must be a way to obtain the data for the leftmost position in a right shift. Similarly, in a left shift, data for the rightmost position must be identified. Referring to FIG. 4, in a left shift example, the register 22 may simply be connected to the opposite end of the multiplexer 24.

In accordance with one embodiment of the present invention, illustrated in connection with a shift of one bit or clock to the right, the leftmost bit in the window is obtained from the data developed in the previous clock. This data is saved by the register 22. Thus, in a shift right example, the leftmost bit is filled by the register 22 and the remaining bits are filled from the data stream, as indicated in FIG. 3.

The sixty-six bit input streaming data indicated at 66 in is fed to a register 22. The register 22 and the data stream together develop the sixty-six possible sixty-six bit candidates. The register 22 creates a copy of the sixty-six bit input. Because the registered copy is delayed with respect to each successive sixty-six bit input, all sixty-six candidates can be formed.

Thus, when a new set of data is written into the register 22, the previous set of data is written out to fill the leftmost positions in a successive series of data frames. Again, the leftmost position is filled from the register 22 because of the right shifting, by one bit, of the window. By successively shifting the window by one bit to the right, eventually valid synchronization bits can be found along the streaming data.

The sixty-six to one multiplexer 24 assembles sixty-six bits seriatim into a data frame and provides that data frame to the sixty-six bit register 26 in one embodiment. In some embodiments, the register 26 may not be used. The first two bits of that register are examined by an exclusive OR gate 28. If both bits are not one or zero, a shift valid signal (sh_valid) is provided to a state machine 30.

The state machine 30 detects valid synchronization headers in a successive number of aligned frames and determines if and when to search for the next valid synchronization header. If the state machine 30 determines that the synchronization header is invalid, it issues a slip signal to the seven bit shift select counter 32 in one embodiment. As a result, the data window is shifted one bit to the right in this example. Thus, the data shifts from shift zero to shift one to shift two, successively looking down the stream of data. Each successive shift may be provided to the register 26 where two bits are examined by the gate 28 to check for the synchronization header, in one embodiment.

If the state machine 30 determines that a proper data frame with synchronization headers has been located, a sixty-six bit output may be issued. If the state machine 30 determines that successive sixty-six bit data frames do not have synchronization bits in the proper positions, the state machine 30 issues a slip signal to the counter 32. In response, the counter 32 issues a signal to shift the window one bit to the right, shifting from one shift to the ensuing shifts until synchronization is achieved. By looking at a sufficient number of data frames, the state machine 30 can determine with high accuracy that the synchronization bits have been repeatedly detected in so many successive frames that synchronization has been achieved.

In some embodiments, a relatively small number of registers may be utilized and tight timing requirements may be achieved due to the placement of registers and reduced register-to-register logic.

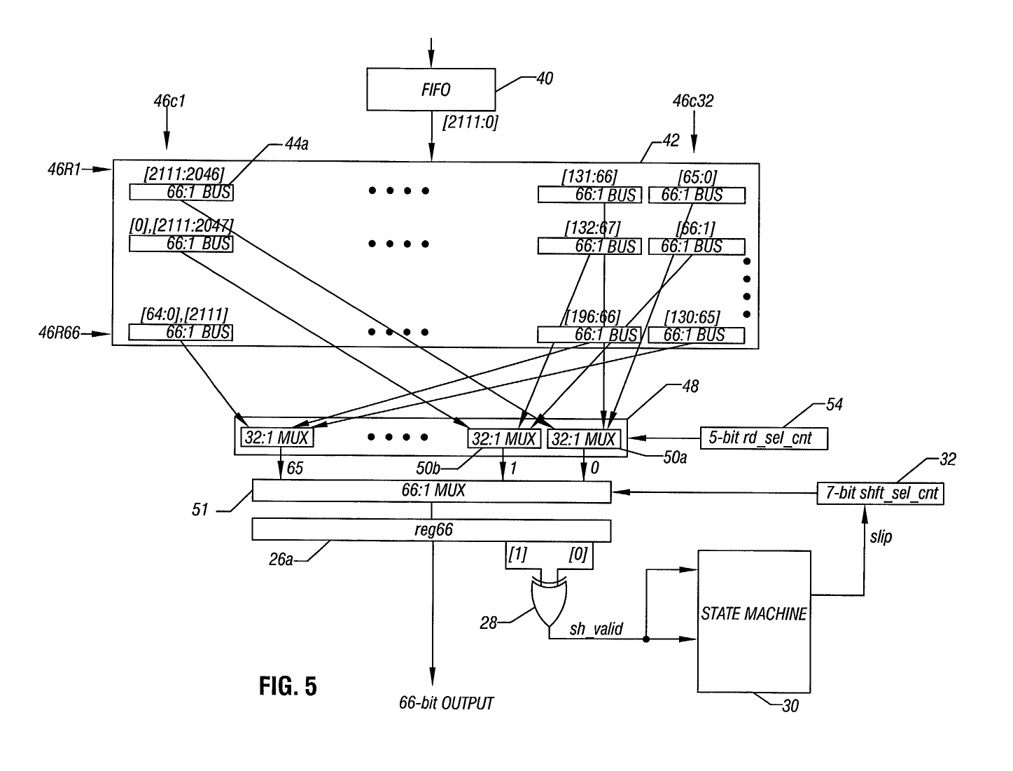

Referring to FIGS. 5 through 7, another embodiment for synchronizing a data frame uses a multiplexing technique. As shown in FIG. 5, the input data stream indicated as [2111:0] is provided from a first in first out (FIFO) buffer 40 (that may correspond to the 1:33 demultiplexer and register 14 of FIG. 2) in one embodiment. The data is fed to an array of sixty-six to one buses 44 arranged in columns 46C1 through 46C32 and rows 46R1 through 46R66, or in other words, in thirty-two columns and sixty-six rows.

Each of the rows 46R1 through 46R66 corresponds to one of the sixty-six shifts described previously from shift zero to shift sixty-five. Each of the columns 46C1 through 46C32 corresponds to sixty-six bits of data from the serial stream made up of one particular shift.

The data from the row 46R1 is bussed to provide thirty-two serial streams to a thirty-two to one multiplexer 50a in an array of thirty-two to one multiplexers 48. Similarly, the next row 46R2 is fed to a multiplexer 50b in the array 48 and so on. The data from the array 48 is provided to a 66:1 multiplexer 51. One shift is then provided in sixty-six bit chunks to a register 26a that arranges the test bits for testing by an exclusive OR gate 28 to determine if they are the synchronization bits. In some embodiments, the register 26a may not be used.

The exclusive OR gate 28 provides a signal indicating whether or not the last two bits in the sixty-six bit frame are valid synchronization bits. This information is provided to a state machine 30 that outputs a slip signal to indicate that the first tested shift is valid or invalid as being synchronized with the synchronization bits.

The slip signal is fed to a seven bit shift select counter 32 that controls the multiplexer 51. As a result, the sixty-six shifts are progressively provided to the register 26a until the correct shift is identified. After the correct shift is identified, it is provided as the sixty-six bit output. Once valid synchronization bits are found by the state machine 30, the shift select counter 32 value remains unchanged and is used for all subsequent sixty-six bit candidates.

A five bit read select counter 54 receives a clock input signal. The counter 54 sequentially increments by one on each clock cycle. Thus, the counter 54 sequentially reads a column 46C1 through 46C32 of a selected row 46R, the row having been selected by the counter 32. Each of the multiplexers 50 in the array 48 is dedicated to a different row of the array 42. The counter 32 provides a signal to the state machine 30 for timing (called slip_done) to indicate when the next row has been successfully selected.

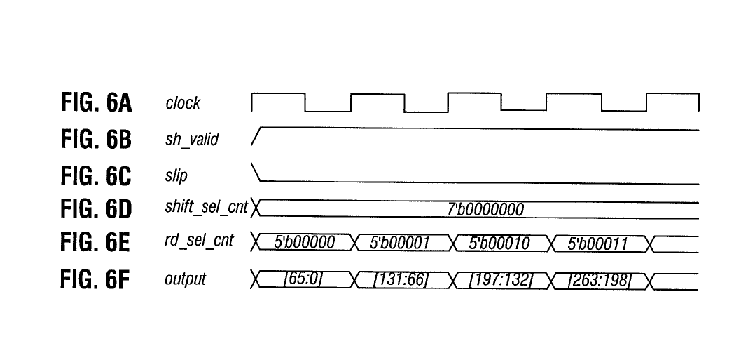

FIG. 6A shows an example of a clock signal fed to the counter 54. FIG. 6B shows an example of a shift valid (sh_valid) signal indicating that the tested bits are valid synchronization bits. The slip signal is not asserted as indicated in FIG. 6C. In this case, the shift select counter 32 has the value 7′b0000000 as indicated in FIG. 6D. The read select counter 54 signal is shown in FIG. 6E and the output is shown in FIG. 6F indicating that the selected shift, the shift zero, does have the synchronization bits in the proper positions. Thus, in this example, the first row of data 46R1 is provided to the multiplexer 50a and the register 26a and is then output as the sixty-six bit output.

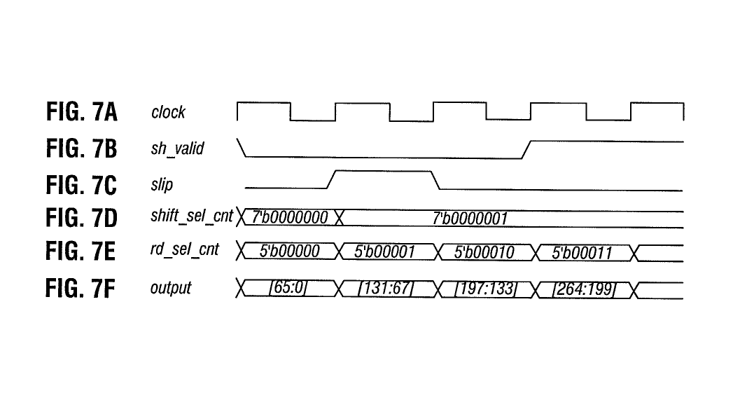

FIG. 7A shows a similar clock signal for the situation where the shift valid signal, shown in FIG. 7B, indicates that synchronization bits were not found. In such case, the slip signal is asserted by the state machine 30 as shown in FIG. 7C. The shift select counter 32 issues a signal shown in FIG. 7D to shift to a different row to test for synchronization bits. In this case, a shift occurs to the second row, row 46R2, which corresponds to shift one. The read select counter 54 output, shown in FIG. 7E, remains unchanged as does the output shown in FIG. 7F. However, the output would not be valid. In other words, the output is not captured unless the state machine 30 indicates that the output is valid.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a data frame of a first size;
demultiplexing said data frame;
writing blocks of the demultiplexed data frame at the first size into a register;
reading blocks of a second size, different from said first size, from said register; and
multiplexing said blocks to form an output data frame of the second size.

2. The method of claim 1 wherein receiving a data frame of a first size includes receiving a 64-bit data frame.

3. The method of claim 2 wherein demultiplexing said data frame includes providing said data frame to a one to thirty-three demultiplexer.

4. The method of claim 3 wherein writing blocks of the demultiplexed data frame at the first size includes writing blocks of 64-bits to a register.

5. The method of claim 4 wherein writing the blocks into a register include writing 2,112 bits into a register.

6. The method of claim 5 including controlling a write pointer at a frequency of approximately 161 MegaHertz.

7. The method of claim 5 wherein reading blocks of the second size includes reading blocks of sixty-six bits from said register.

8. The method of claim 7 including controlling a read pointer at a frequency of approximately 156 MegaHertz.

9. The method of claim 7 wherein multiplexing said blocks to form an output data frame of a second size includes forming an output data frame by using a thirty-two to one multiplexer.

10. The method of claim 1 including converting a sixty-four bit data frame to a sixty-six bit data frame.

11. A device comprising:
a demultiplexer coupled to receive a data frame of a first size;
a register coupled to receive data from said demultiplexer; and
a multiplexer coupled to the output of said register, the output of said multiplexer being a data frame of a second size different from said first size.

12. The device of claim 11 including a first counter to control the writing of data from said demultiplexer to said register.

13. The device of claim 11 including a second counter to control the reading of data from said register to said multiplexer.

14. The device of claim 11 wherein data is written to said register at approximately 161 MegaHertz and data is read from said multiplexer at approximately 156 MegaHertz.

15. The device of claim 11 wherein said demultiplexer receives a data frame of 64-bits and said multiplexer outputs a data frame of 66-bits.

16. The device of claim 11 wherein said demultiplexer is a one to thirty-three demultiplexer.

17. The device of claim 11 wherein said multiplexer is a thirty-two to one multiplexer.

18. The device of claim 11 wherein said demultiplexer writes data to said register in 64-bit blocks.

19. The device of claim 11 wherein said multiplexer reads data from said register in 66-bit blocks.

20. The device of claim 11 wherein said demultiplexer writes data in blocks of a first size to said register and said multiplexer reads data in blocks of a second size, different from said first size, from said register.

21. The device of claim 11 wherein said device is part of a physical coding sublayer.

22. The device of claim 21 wherein said device is part of a receiver in a fiber optic network.

23. A method comprising:
receiving a stream of data;
defining a window of a predetermined size within said stream;
examining the window to determine whether at least one synchronization bit is located within the data in the window; and
shifting the window along said stream if a valid synchronization bit is not found in the window.

24. The method of claim 23 including shifting the window by a predetermined number of bits and filling the opening created by shifting with a bit from a previous cycle.

25. The method of claim 24 including storing bits from each successive cycle and providing bits from previous cycles to fill openings created by shifting in subsequent cycles.

26. The method of claim 23 including successively shifting said window by one bit along said stream of data until valid synchronization bits are located.

27. The method of claim 23 including locating a pair of synchronization bits in a 66-bit data frame.

28. The method of claim 23 including receiving a block of data of said predetermined size in a multiplexer and multiplexing said data into a register.

29. The method of claim 28 including applying two of said bits from said register to an exclusive OR gate.

30. The method of claim 23 including providing 66-bit blocks in successively shifted sets, each block shifted one-bit relative to the other block, to a multiplexer and successively applying said 66-bit blocks to a register.

31. The method of claim 23 including providing serial data to a first array of multiplexers arranged in rows and columns, wherein each row corresponds to a different window position along the stream of data.

32. The method of claim 31 including writing the data from a row of multiplexers in a first array to an array of multiplexers in a second array.

33. A device comprising:
a first storage element to receive a stream of data;
an element to define a window of a predetermined size within said stream;
a detector to examine the window to determine whether at least one synchronization bit is located within the data in the window; and
a component to shift data along said stream into said window if a valid synchronization bit is not found in the window.

34. The device of claim 33 including:
a multiplexer coupled to said data stream and said first storage element to receive data;
a second storage element coupled to the output of said multiplexer to receive a data frame;
a gate coupled to said second storage element to test for the presence of at least one synchronization bit in said data frame in said second storage element; and
a control to determine whether or not valid synchronization bits have been located in a series of data frames.

35. The device of claim 34 wherein said control is a state machine.

36. The device of claim 35 including a counter, wherein said state machine controls the counter that controls the operation of said multiplexer.

37. The device of claim 34 wherein said first and second registers are sixty-six bit registers.

38. The device of claim 37 wherein said multiplexer is a sixty-six to one multiplexer.

39. The device of claim 38 wherein said multiplexer receives sixty-six shifts.

40. The device of claim 34 wherein said gate is an exclusive OR gate.

41. The device of claim 40 wherein said exclusive OR gate tests two bits of each data frame for the presence of synchronization bits.

42. The device of claim 34 wherein said first storage element stores bits from each successive cycle and provides bits from previous cycles to fill openings created by shifting in subsequent cycles.

43. The device of claim 42 including a counter that receives a signal from said control and issues a signal to said multiplexer to shift a window of data output by said multiplexer along said serial data stream.

44. The device of claim 33 wherein said first storage element includes an array of multiplexers arranged in rows and columns.

45. The device of claim 44 wherein each row of multiplexers provides one window of data.

46. The device of claim 45 including a second array of multiplexers coupled to said first array of multiplexers.

47. The device of claim 46 including a register that receives the output from said second array of multiplexers.

48. The device of claim 47 including a gate to determine whether or not at least one bit in said register is a synchronization bit.

49. The device of claim 48 including a state machine coupled to the output of said gate.

50. The device of claim 49 wherein said gate is an exclusive OR gate.

51. The device of claim 49 including a state machine coupled to the output of said gate.

52. The device of claim 51 including a counter coupled to said state machine and said first array of multiplexers to select a row of multiplexers in said first array.

53. The device of claim 51 including a gear box to convert 64-bit data frames to 66-bit data frames.

54. The device of claim 53 further including a physical coding sublayer.

55. The device of claim 54 where said device is a receiver for a fiber optic network.
